(19) United States
(12) Patent Application Publication
(10) Pub. No.: US 2005/0129369 A1
(43) Pub. Date: Jun. 16, 2005

(54) Multiconductor surface-mount connector for printed-circuit board

(75) Inventor: Joris Siliakus, Schalksmuhle (DE)

Correspondence Address: THE FIRM OF KARL F ROSS, 5676 RIVERDALE AVENUE, PO BOX 900, RIVERDALE (BRONX), NY, 10471-0900, US

(73) Assignee: LUMBERG CONNECT GMBH & CO. KG

(21) Appl. No.: 11/001,695

(22) Filed: Dec. 1, 2004

(30) Foreign Application Priority Data
Dec. 10, 2003 (DE) 10358079.4

(51) Int. Cl. G02B 6/36

(52) U.S. Cl. 385/88

(57) ABSTRACT

A connector has a body having a mounting end formed with a pair of side surfaces and an end face transversely bridging the side surfaces. The body is formed with a row of seats open at the body end face and alignable with the traces. Respective identical flat conductive contacts fixed in the seats each have a connection end projecting from the body end face and having a pair of oppositely directed side edges and an end edge transversely bridging the side edges. One of the edges of each of the contacts is fixed, typically by solder, to a respective one of the traces. The side surfaces are oppositely directed and generally parallel and the contact side edges are substantially coplanar with the respective body side faces.

### FIELD OF THE INVENTION

The present invention relates to an electrical connector. More particularly this invention concerns a multiconductor surface-mount connector for a printed-circuit board.

### BACKGROUND OF THE INVENTION

It is frequently necessary to provide a printed-circuit board with a connector that allows a cable or a piece of electronic equipment to be easily connected to and disconnected from the circuitry on the board. For instance a cell phone is normally provided on its lower end with a socket adapted to fit with a miniplug for connection of the cell phone to a hands-free attachment or to a docking station connected to a computer. When the equipment is small, the connector is provided right on the circuit board.

To this end as described in U.S. Pat. Nos. 5,951,335 of Kurotori and 6,328,600 of Fujiki such a connector has a dielectric body forming a row of open seats alignable with the traces of a printed-circuit board to which the connector is to be secured. Respective identical flat conductive contacts fixed in the seats each have a connection end projecting from body. Means such as solder fixes the edge of each of the connection ends to a respective one of the traces. Such systems can be adapted for mounting of the connector on end or on one side.

The disadvantage of this assembly is that it is occasionally necessary to orient the connector facing out or facing in, depending on what orientation is needed of the equipment being seated on the connector. This is not an issue when the connector is a cable, but with a cell phone such a socket might be needed to orient the phone facing the user for hand-free use, or facing away when used as a camera. This is not possible with the prior-art connectors.

### OBJECTS OF THE INVENTION

It is therefore an object of the present invention to provide an improved multiconductor surface-mount connector for printed-circuit.

Another object is the provision of such an improved multiconductor surface-mount connector for printed-circuit that overcomes the above-given disadvantages, in particular that can be mounted in any useful position on the board.

### SUMMARY OF THE INVENTION

A connector according to the invention has a body having a mounting end formed with a pair of side surfaces and an end face transversely bridging the side surfaces. The body is formed with a row of seats open at the body end face and alignable with the traces. Respective identical flat conductive contacts fixed in the seats each have a connection end projecting from the body end face and having a pair of oppositely directed side edges and an end edge transversely bridging the side edges. One of the edges of each of the contacts is fixed, typically by solder, to a respective one of the traces.

Thus with this system there are three different mounting orientations for the connector. It can be stood on end with the contact end edges soldered to the circuit traces, or laid on either face with the respective contact side faces soldered down. Such three-way mounting allows the manufacturer of the equipment employing the connector to stock a single part and use it in any normally encountered application.

According to the invention the side surfaces are oppositely directed and generally parallel and the contact side edges are substantially coplanar with the respective body side faces. This makes it possible to secure the normally mainly dielectric connector body to the board also for a very secure mounting.

The side faces and edges are all substantially planar and each end edge is substantially perpendicular to the respective side edges. Thus the three mounting positions are perpendicular to one another.

Each contact in accordance with the invention further has a contact end exposed laterally in the body. Furthermore, the body is formed with respective laterally open slots aligned with the seats and receiving the contact ends of the contacts. Each contact is formed as a stiff piece of sheet metal. having broad faces bridging the respective edges, the slots are laterally throughgoing, and the body includes a cover plate overlying one side and laterally closing the slots on one side. Such constructions is handy when the connector is used to hold a cell phone, as the cover plate can be metallic and conductive to shield the contacts.

In order that the contacts can deflect and bear elastically on contacts or terminals of the piece of equipment being fitted to the connector, the contact ends are relatively slim and the body mounting ends are relatively wide.

### BRIEF DESCRIPTION OF THE DRAWING

The above and other objects, features, and advantages will become more readily apparent from the following description, reference being made to the accompanying drawing in which:

FIG. 1 is a perspective view of the connector according to the invention; and

FIGS. 2, 3, and 4 are sections through the connector in three different mounting positions on a circuit board.

### SPECIFIC DESCRIPTION

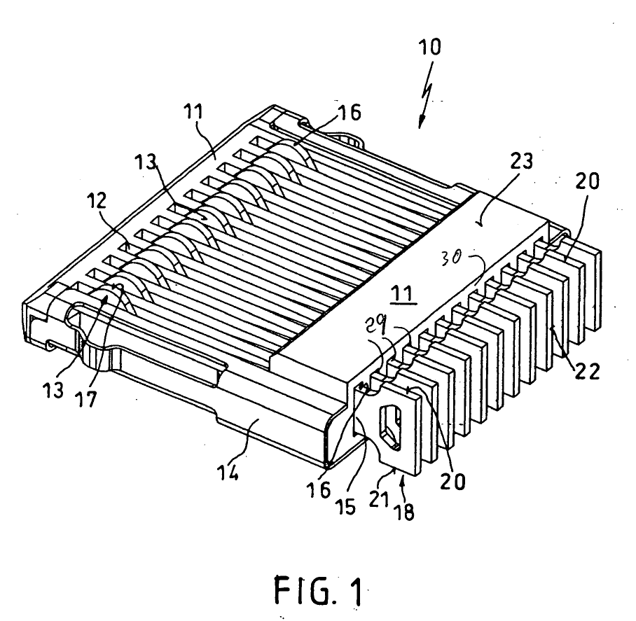

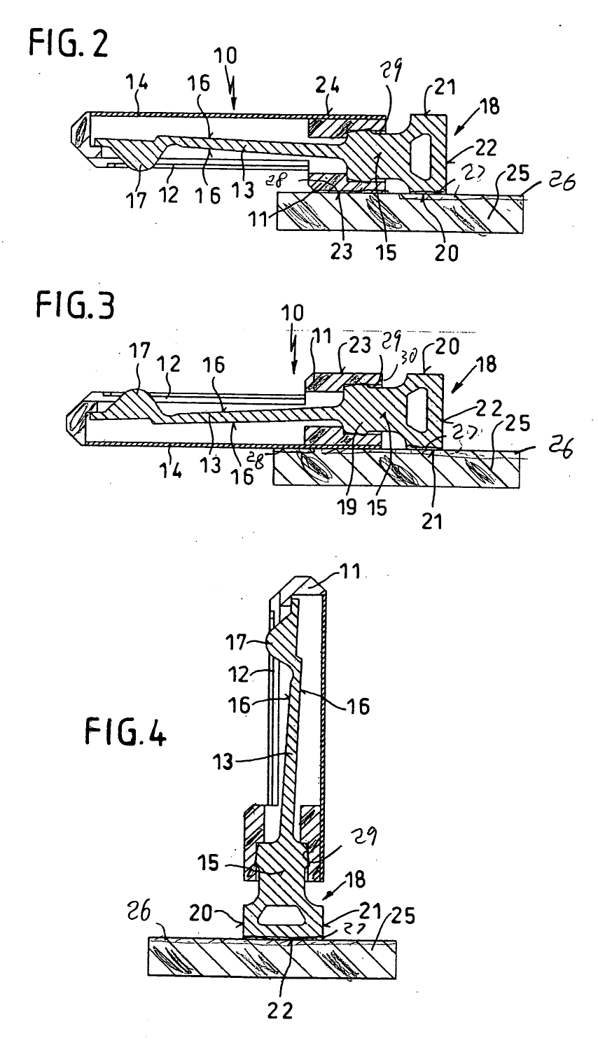

As seen in the drawing, a connector 10 according to the invention has a plastic body 11 formed with a plurality of transversely throughgoing seat-forming slots 12 and with a plurality of seat passages 29 each aligned with a respective one of the slots 12. One side, one end, and both edges of the body 11 are covered by a U-shaped metal shield plate 14 in effect forming part of the body 11, so that the throughgoing slots 12 are only open on one side that faces in FIGS. 1 and 3, down in FIG. 2.

Respective identical conductors 13 formed as flat rolled-metal strips are held in the slots 12. Each such contact 13 has a pair of planar, parallel, and oppositely directed broad faces 15 and a pair of narrow edges 16 bridging the faces 15. On the sides of the slot 12 not covered by the plate 14, each face 16 is formed with a bump 17 that projects laterally out of the body 11 and that serves for connection to a conductor or terminal of an unillustrated contact shoe or socket of, for instance, a cell phone. Each contact 13 further has a wide rear end 19 force-fitted in the respective seat 29 so that all of the contact faces 15 are parallel and the contacts 13 are fixed in the body 1 with, of course, the ends with the bumps laterally elastically deflectable into the respective slots 12.

In accordance with the invention each contact 13 further has a rear end 18 projecting from the respective seat 29 and formed with a pair of planar and parallel side edges 20 and 21 that are coplanar with respective planar side faces 23 and 24 of the body 11. The end 18 also has a planar end edge 22 extending perpendicularly between the side edges 20 and 21 and parallel to but spaced from a rear end face 30 of the body 11.

Such a connector can be mounted as shown in FIGS. 2, 3, and 4 on a printed circuit board 25 having traces 26 in three different positions. FIG. 2 shows how the edges 20 sit flat on the board 25 with solder 27 physically and electrically connecting the contacts 13 to the traces 26. A layer 28 of glue can also be provided between the face 23 of the body 11 and the board 25. In this position the connector 10 is open toward the board 25, that is the bumps 17 of the contacts 13 are exposed toward the board 25.

FIG. 2 shows how the connector 10 can be mounted open away from the board, with the edges 21 soldered to the traces 26 and the face 24, actually formed by the shell plate 14, adhered to the board.

FIG. 3 shows the connector 10 mounted on end, with the end faces 22 secured by solder 27 to the traces 26, in which case the connector 10 is open parallel to the board 25.

1. In combination with a printed-circuit board having a face carrying a plurality of conductive traces, a connector comprising:
a body having a mounting end formed with a pair of side surfaces and an end face transversely bridging the side surfaces, the body forming a row of seats open at the body end face and alignable with the traces;
respective identical flat conductive contacts fixed in the seats and each having a connection end projecting from the body end face and having a pair of oppositely directed side edges and an end edge transversely bridging the side edges; and
means fixing one of the edges of each of the contacts to a respective one of the traces.

2. The circuit-board connector defined in claim 1 wherein the side surfaces are oppositely directed and generally parallel and the contact side edges are substantially coplanar with the respective body side faces.

3. The circuit-board connector defined in claim 1 wherein the side faces and edges are all substantially planar.

4. The circuit-board connector defined in claim 3 wherein each end edge is substantially perpendicular to the respective side edges.

5. The circuit-board connector defined in claim 1 wherein each contact further has a contact end exposed laterally in the body.

6. The circuit-board connector defined in claim 5 wherein the body is formed with respective laterally open slots aligned with the seats and receiving the contact ends of the contacts.

7. The circuit-board connector defined in claim 6 wherein each contact is formed as a stiff piece of sheet metal. having broad faces bridging the respective edges.

8. The circuit-board connector defined in claim 6 wherein the slots are laterally throughgoing and the body includes a cover plate overlying one side and laterally closing the slots on one side.

9. The circuit-board connector defined in claim 5 wherein the contact ends are relatively slim and the body mounting ends are relatively wide.

10. The circuit-board connector defined in claim 1 wherein the means is solder joining each trace to the respective contact edge.
